(19) United States
(12) Patent Application Publication
(10) Pub. No.: US 2014/0178139 A1
(43) Pub. Date: Jun. 26, 2014

(54) METHOD OF MANUFACTURING SUPER HARD ALLOY CONTAINING CARBON NANOTUBES, SUPER HARD ALLOY MANUFACTURED USING SAME, AND CUTTING TOOL COMPRISING SUPER HARD ALLOY

(71) Applicant: KOREA INSTITUTE OF MACHINERY AND MATERIALS, Daejeon (KR)

(72) Inventors: KyungTae KIM, Busan (KR); GOOK-HYUN HA, Busan (KR)

(73) Assignee: KOREA INSTITUTE OF MACHINERY AND MATERIALS, Daejeon (KR)

(21) Appl. No.: 14/076,460

(22) Filed: Nov. 11, 2013

(30) Foreign Application Priority Data
Dec. 21, 2012 (KR) 10-2012-0150568

(51) Int. Cl. B22F 5/00; B23B 27/14

(52) U.S. Cl. CPC B22F 5/00; B23B 27/14
USPC 407/119; 419/11; 75/243

(57) ABSTRACT

Disclosed is a method of manufacturing a super hard alloy containing carbon nanotubes, including (a) forming a carbon nanotube-metal composite from carbon nanotubes and metal powder, (b) mixing the carbon nanotube-metal composite obtained in (a) with hard-phase powder, (c) molding the powder mixture obtained in (b), and (d) sintering the molded body obtained in (c). In the method of the invention, the reaction between carbon nanotubes and transition metal carbide in the super hard alloy is minimized, thus maximizing an increase in toughness by virtue of the addition of carbon nanotubes, thereby obtaining the super hard alloy having both high hardness and high toughness. The super hard alloy containing carbon nanotubes manufactured using the method of the invention has high hardness and high toughness, and thus can be effectively utilized in cutting tools, molds, wear-resistant members, heat-resistant structural materials, etc.

### CROSS REFERENCE RELATED APPLICATION

This application claims foreign priority of Korean Patent Application No. 10-2012-0150568, filed on Dec. 21, 2012, which is incorporated by reference in its entirety into this application.

### BACKGROUND OF THE INVENTION

1. Field of the Invention

The present invention relates to a method of manufacturing a super hard alloy, a super hard alloy manufactured thereby, and a cutting tool comprising the super hard alloy, and, more particularly, to a method of manufacturing a super hard alloy containing carbon nanotubes, a super hard alloy manufactured thereby, and a cutting tool comprising the super hard alloy.

2. Description of the Related Art

A super hard alloy refers to an alloy obtained by sintering hard-phase powder including Group IV, V and VI transition metal carbides having very high hardness with iron-group metal powder such as Fe, Co, Ni, etc. having high toughness and is particularly superior in mechanical properties in the range from room temperature to high temperature. A typical example of a super hard alloy that is useful in cutting tools, wear-resistant parts and molds is a WC—Co-based alloy.

The mechanical properties of the super hard alloy are affected by chemical composition, particle size distribution of hard-phase particles such as transition metal carbides, and carbon content, microstructure, porosity, defects, etc., of the alloy. In particular, the size of hard-phase particles and the thickness (mean free path) of the metal layer which is a soft phase between the hard-phase particles are regarded as the most important factors which determine the mechanical properties of the super hard alloy. In order to obtain high hardness and improve mechanical properties, there are needs to decrease the size of hard-phase particles and the thickness of the metal layer between the hard-phase particles.

However, when hard-phase particles having a size of hundreds of nanometers are used or when the thickness of the metal layer between the hard-phase particles is decreased, hardness may be improved and toughness may comparatively decrease. Hence, the present invention is intended to solve such problems in such a manner that carbon nanotubes (CNTs) are uniformly dispersed in a metal binder of the super hard alloy thus enhancing strength of the metal layer and connecting grain boundaries by means of CNTs to thereby effectively prevent creation and propagation of cracks.

However, the case where a super hard alloy is manufactured by mechanically mixing hard-phase powder such as transition metal carbide, metal powder and CNTs together and performing molding and sintering may cause problems in which upon sintering, the transition metal carbide may react with CNTs to form a carbide, or hardness of the super hard alloy may decrease somewhat due to changes in the stoichiometric ratio of tungsten carbide, and also CNTs may aggregate. Korean Unexamined Patent Publication No. 10-2011-0044474 (Laid-open date: Apr. 29, 2011), entitled “Nano-structured metal carbide-CNT composite and manufacturing method thereof,” is advantageous in that a metal carbide and CNTs are mixed together to make a composite material, thus preventing grain growth of the metal carbide. However, the above patent does not provide techniques for solving problems in which abnormal grain growth of the coarse metal carbide as in the disclosed microstructure occurs, and CNTs may aggregate or may react with the metal carbide. Thus, it is difficult to expect the effects of the invention, which may increase toughness via enhancement of the metal binder by virtue of CNTs and functions to make a strong soft phase and to improve wear resistance, from the prior invention.

In order to improve both hardness and toughness through the addition of CNTs, it is essential that CNTs are uniformly dispersed in the metal binder. In the case of cutting tools, which are typical applications of the super hard alloy, as high strength and hardness of a material to be cut are increasingly required these days, a material having high wear resistance against friction with the material to be cut and high thermal conductivity so as to efficiently emit heat generated upon friction is required. With the goal of solving this problem, CNTs having the same coefficient of friction as in the graphite surface and high thermal conductivity of 500 W/m K or more are utilized in super hard alloys so as to exhibit properties thereof, making it possible to develop novel super hard alloy materials having superior properties.

### SUMMARY OF THE INVENTION

Accordingly, the present invention has been made keeping in mind the above problems encountered in the related art, and an object of the present invention is to provide a method of manufacturing a super hard alloy containing CNTs, a super hard alloy manufactured thereby and a cutting tool comprising the super hard alloy, wherein, upon manufacturing the super hard alloy containing CNTs, the reaction between CNTs and hard-phase particles may be minimized and thus CNTs may be uniformly dispersed in a binder.

In order to accomplish the above object, the present invention provides a method of manufacturing a super hard alloy containing CNTs, comprising (a) forming a CNT-metal composite from CNTs and metal powder; (b) mixing the CNT-metal composite obtained in (a) with transition metal carbide powder; (c) molding the powder mixture obtained in (b); and (d) sintering the molded body obtained in (c). In addition, the present invention provides a super hard alloy containing CNTs, manufactured using the above method, and a cutting tool comprising the super hard alloy.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a flowchart illustrating a process of manufacturing a super hard alloy containing CNTs according to the present invention;

FIG. 2 is a schematic view illustrating the microstructure of the super hard alloy, which may be manufactured using the process of manufacturing a super hard alloy containing CNTs according to the present invention;

FIG. 3 is a scanning electron microscope (SEM) image illustrating a CNT-Co powder composite obtained in the course of the example according to the present invention;

FIG. 4 is an SEM image illustrating WC/CNT-Co powder obtained in the course of the example according to the present invention;

FIG. 5 is a graph illustrating the results of analysis of X-ray diffraction (XRD) of WC/CNT-Co powder obtained in the course of the example according to the present invention;

FIG. 6 is an SEM image illustrating the surface microstructure of the super hard alloy containing CNTs manufactured in the example according to the present invention;

FIG. 7 is a graph illustrating the results of measuring hardness (H_{V}) of the super hard alloys manufactured in the example according to the present invention and the comparative example; and

FIG. 8 is a graph illustrating the results of measuring fracture toughness (K_{IC}) of the super hard alloys manufactured in the example according to the present invention and the comparative example.

### DESCRIPTION OF SPECIFIC EMBODIMENTS

Hereinafter, a detailed description will be given of the present invention.

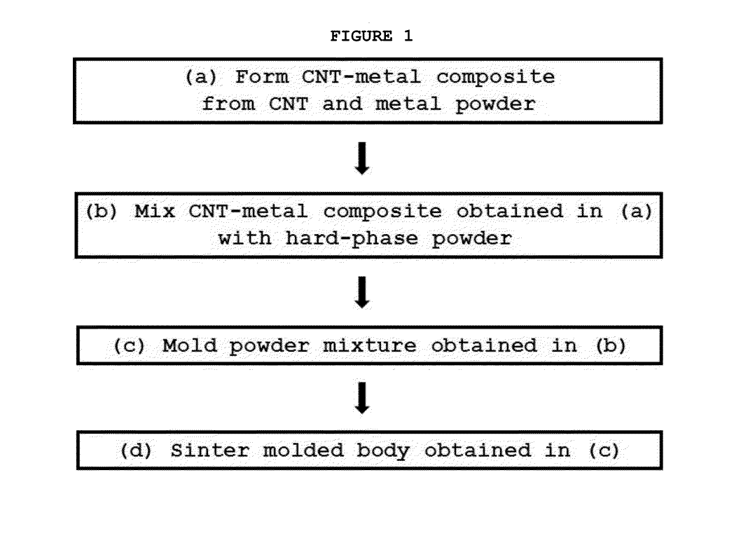

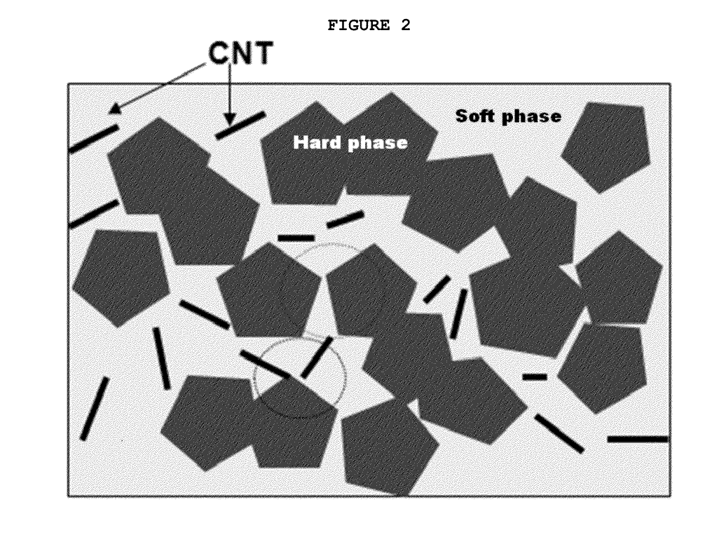

FIG. 1 is a flowchart illustrating a process of manufacturing a super hard alloy containing CNTs according to the present invention. As illustrated in FIG. 1, the method of manufacturing the super hard alloy containing CNTs include (a) forming a CNT-metal composite from CNTs and metal powder; (b) mixing the CNT-metal composite obtained in (a) with hard-phase powder; (c) molding the powder mixture obtained in (b); and (d) sintering the molded body obtained in (c). The method of manufacturing the super hard alloy containing CNTs according to the present invention enables the super hard alloy having a microstructure as illustrated in FIG. 2 to be manufactured.

The method of manufacturing a super hard alloy containing CNTs according to a preferred embodiment of the invention is stepwisely specified below.

In the method of the invention, (a) refers to forming the CNT-metal composite from CNTs and metal powder.

As such, examples of the metal powder for forming the CNT-metal composite may include iron (Fe) powder, cobalt (Co) powder, nickel (Ni) powder or powder mixtures thereof.

Although the mechanical properties, shape, purity, etc., of the CNTS for forming the CNT-metal composite are not particularly limited, CNTs preferably have a strength of 10˜50 GPa grade, an elastic modulus of 0.5˜1.0 TPa grade, an aspect ratio of 10˜1,000, a purity of 95% or more, and a thermal conductivity of 500˜1800 W/m K.

The process for forming the CNT-metal composite is not particularly limited so long as it is able to form such a composite. The CNTs and the metal powder may be mechanically mixed via milling using a ball mill, a planetary mill, an attrition mill, etc., or CNTs and a metal precursor may be used.

Specific examples of the use of the CNTS and the metal precursor may include forming a CNT-metal composite by subjecting a CNT-metal precursor mixed solution to drying, calcination and reduction, or forming a CNT-metal composite by subjecting a CNT-metal precursor mixed solution to oxidation using an oxidant and then reduction. As such, it is noted that the metal binder powder be prepared in the form of CNTs being dispersed in the metal powder. The reason is that CNTs contained in the metal binder should not decompose via the reaction with WC and the carbon content has to be maintained constant. The final composition of the binder may include Ni, Co, and Fe, which may be used alone or in combinations of two or more at an appropriate ratio.

In the method of the invention, (b) refers to mixing the CNT-metal composite obtained in (a) with hard-phase powder.

As such, the hard-phase powder is preferably at least one selected from the group consisting of tungsten carbide (WC), titanium carbide (TiC), titanium nitride (TiN), titanium carbonitride (TiCN) and titanium aluminum nitride (TiAlN). Also, the hard-phase powder may be mixed in such a manner that the powder may be mixed with the CNT-metal composite obtained in (a), or the CNT-metal composite obtained in (a) may be added upon carbonization of powder in a salt state of tungsten, titanium, etc., thus forming a powder composite.

In (b), the CNT-metal composite and the hard-phase powder may be mixed, but a known organic additive such as a binder, a releasing agent, a dispersant, a plasticizer, etc, may be further added.

In the method of the invention, (c) refers to molding the powder mixture obtained in (b). The molding process used in this step is not limited so long as it provides a molded body having a shape adapted to be sintered using a process such as press molding, cold isostatic pressing, powder injection molding, etc. Particularly useful is press molding because it is easy to form a molded body.

In the case where the molded body is made using press molding, the kind of a device used therefor is not particularly limited, but any device may be used so long as molding is performed at a pressure of 30 MPa or more. In the case where press molding is performed at a pressure less than 30 MPa, the resulting molded body does not have a sufficient density, making it impossible to obtain a very densely compact sintered body.

The molded body may be formed without limitation of a shape so as to be adapted for end uses, such as pellets, bars, etc.

In the method of the invention, (d) refers to sintering the molded body obtained in (c).

The sintering temperature range may vary depending on the system of the super hard alloy to be manufactured, and may be appropriately selected in the temperature range which enables liquid sintering, taking into consideration sinterability and profitability. For example, in the case of a WCCo system, sintering is preferably carried out at 1350˜1500° C.

Upon sintering, the sintering temperature may be maintained constant, or the sintering temperature may be gradually decreased or increased from the upper or lower limit of the temperature range.

The sintering time is preferably set to 2˜6 hr, in consideration of sinterability and profitability.

In regard to the sintering atmosphere, sintering may be performed under atmospheric pressure or in a vacuum, or may be conducted in a reducible gas atmosphere or an inert gas atmosphere.

In addition, the present invention provides a super hard alloy containing CNTs manufactured by the above method.

In the super hard alloy according to the present invention, CNTs are preferably contained in an amount of 0.5˜5 vol % based on the volume of the super hard alloy except for a hard phase. In an initial stage, toughness may increase in proportion to an increase in the amount of CNTs. However, if the amount of CNTs is greater than 5 vol %, the amount of the metal binder may comparatively decrease, and thus toughness may deteriorate rather. In contrast, if the amount of CNTs is less than 0.5 vol %, enhancement in toughness becomes insignificant.

The super hard alloy according to the present invention has high hardness and high toughness. Specifically, it preferably has a Vickers hardness (H_{V}) of 2000 or more, and a fracture toughness of (K_{IC}) of 4 MPa m^{1/2} or more. When Vickers hardness (H_{V}) is 2000 or more, superior wear resistance may be obtained, and also when fracture toughness (K_{IC}) is 4 MPa m^{1/2} or more, a variety of members manufactured using the super hard alloy according to the present invention may be expected to exhibit superior crack resistance and chipping resistance. On the other hand, Vickers hardness (H_{V}) may be set to 2200 or less in order to prevent toughness from decreasing due to excessively high hardness, as necessary.

In addition, the present invention provides a cutting tool comprising the super hard alloy containing CNTs.

Because the super hard alloy according to the present invention is excellent in terms of hardness and toughness, it may be usefully applied to cutting tools, molds, wear-resistant members, heat-resistant structural materials, etc. Particularly in the case of a cutting tool for cutting a material to be cut using a cutting edge thereof, the cutting edge may comprise the super hard alloy according to the present invention. When the super hard alloy according to the present invention is used as the cutting edge of a cutting tool in this way, the temperature of the cutting edge is not excessively increased and thus the machined surface of the material to be cut may be finished so as to become smooth and glossy. Furthermore, when a hard coating layer is additionally formed on the cutting tool, wear resistance and strength may be enhanced, and thus heat-resistant alloys including nickel-based alloys or cobalt-based alloys, such as Inconel alloys, iron-based alloys such as Incoloy alloys, etc., may be very effectively processed.

A better understanding of the present invention may be obtained via the following examples which are set forth to illustrate, but are not to be construed as limiting the present invention.

### EXAMPLE

### Formation of WC/CNT-Co Super Hard Alloy with CNTs

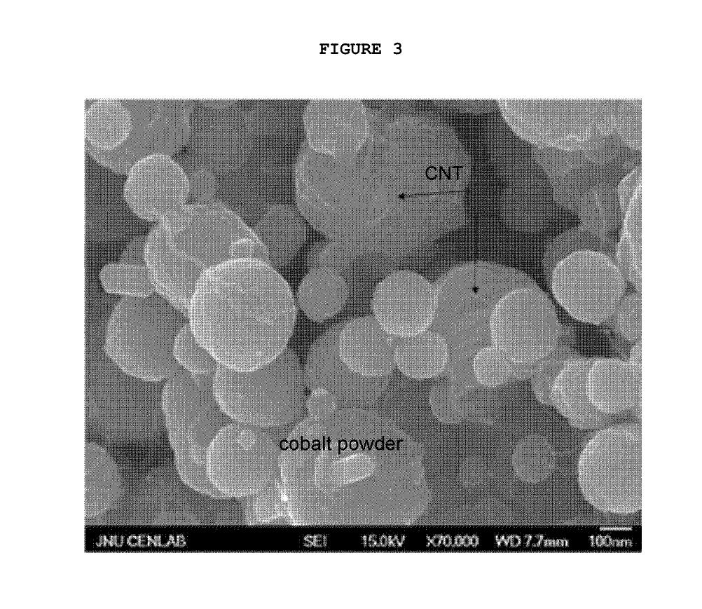

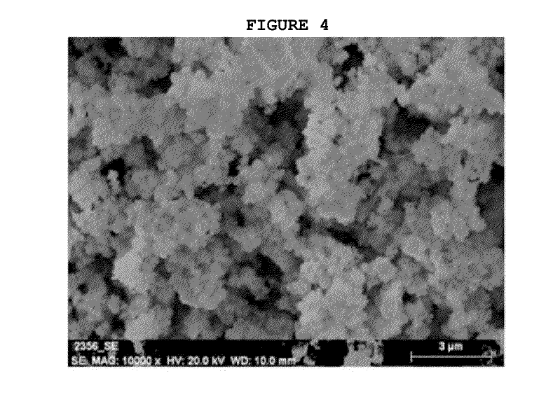

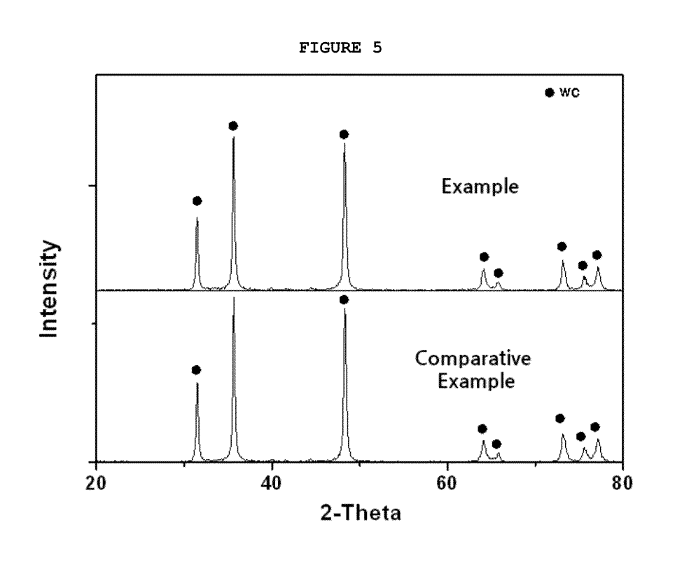

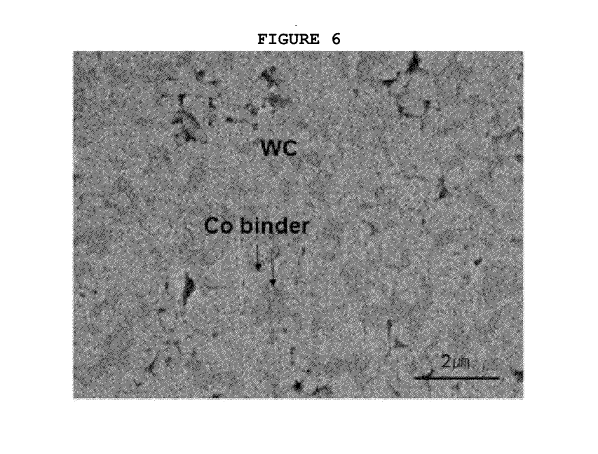

To incorporate CNTs into Co powder, a chemical process was performed in such a manner that Co nanoparticles were formed around the surface of CNTs, followed by carrying out mechanical milling, thus synthesizing a CNT-Co powder composite comprising 0.5 vol % of CNTs and 99.5 vol % of Co powder and having CNTs dispersed in the Co powder as illustrated in FIG. 3. Subsequently, 10 wt % of WC nanopowder having a size of about 200 nm was mixed with 90 wt % of the CNT-Co powder composite using a mechanical milling process, thus synthesizing WC/CNT-Co powder having a shape illustrated in FIG. 4. The WC/CNT-Co powder thus synthesized can be clearly seen to have a WC phase as illustrated in FIG. 5. The WC/CNT-Co powder was subjected to press molding using an air press thus obtaining pellets. The pellets were sintered at 1400° C. for 2 hr in a hydrogen atmosphere, thus manufacturing a WC/CNT-Co super hard alloy. The WC/CNT-Co super hard alloy thus manufactured manifests a microstructure in which WC grains having a size of about 500 nm are connected by the CO binder as illustrated in FIG. 6.

### Comparative Example

### Formation of WC—Co Super Hard Alloy without CNTs

10 wt % of WC nanopowder having a size of about 200 nm was mixed with 90 wt % of Co powder using a mechanical milling process. The powder mixture thus obtained was subjected to press molding using an air press thus obtaining pellets. The pellets were sintered at 1400° C. for 2 hr in a hydrogen atmosphere, thus manufacturing a WC—Co super hard alloy.

### Test Example

### Evaluation of Mechanical Properties of Super Hard Alloys Manufactured in Example and Comparative Example

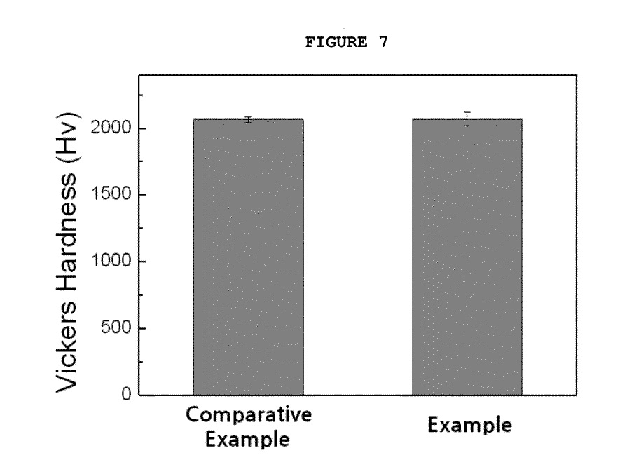

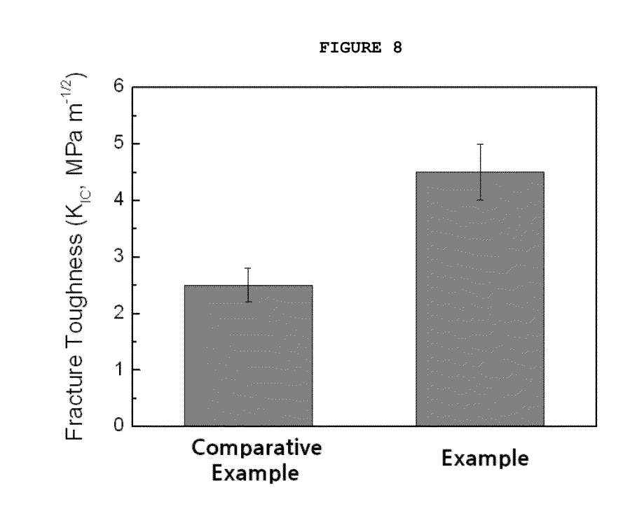

The Vickers hardness (H_{V}) was measured to be 2060 on average in the comparative example, and was measured to be 2070 in the example wherein CNTs were added (FIG. 7). The fracture toughness (K_{IC}) was measured to be 2.5 MPa m^{1/2} in the comparative example, and was measured to be 4.5 MPa m^{1/2} in the example (FIG. 8).

The addition of CNTs did not greatly increase hardness but remarkably enhanced fracture toughness (K_{IC}) by 1.8 times or more. This is considered to be due to the addition of CNTs to thus enhance the Co binder matrix and prevent the propagation of cracks. When the example and the comparative example, both of which show WC average grains having a particle size of 500 nm and a sintering density of 99.2%, are compared with each other, toughness is regarded as being enhanced by virtue of CNTs.

Consequently, in the case where the super hard alloy containing CNTs according to the present invention is manufactured, an effect of CNTs on enhancing toughness may be maximized.

As described hereinbefore, the present invention provides a method of manufacturing a super hard alloy containing CNTs, a super hard alloy manufactured thereby, and a cutting tool comprising the super hard alloy. According to the present invention, the reaction between the CNTs and the transition metal carbide in the super hard alloy can be minimized, thus maximizing an increase in toughness by virtue of the addition of CNTs, ultimately obtaining a super hard alloy which is superior in both hardness and toughness. Also, because of wear resistance and high thermal conductivity of CNTs, the super hard alloy containing CNTs can be utilized as a next-generation material for cutting tools having high wear resistance and high thermal conductivity.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A method of manufacturing a super hard alloy containing carbon nanotubes, comprising:
(a) forming a carbon nanotube-metal composite from carbon nanotubes and metal powder;
(b) mixing the carbon nanotube-metal composite obtained in (a) with hard-phase powder, thus obtaining a powder mixture;
(c) molding the powder mixture obtained in (b), thus obtaining a molded body; and
(d) sintering the molded body obtained in (c).

2. The method of claim 1, wherein the metal powder in (a) is at least one selected from among Fe powder, Co powder and Ni powder.

3. The method of claim 1, wherein (a) is performed using milling.

4. The method of claim 3, wherein the milling is selected from among ball milling, planetary milling, and attrition milling.

5. The method of claim 1, wherein the hard-phase powder in (b) is at least one selected from among WC powder, TiC powder, TiN powder, TiCN powder and TiAlN powder.

6. The method of claim 1, wherein the metal powder in (a) is any one or a mixture of two or more selected from among Fe powder, Co powder and Ni powder, and the hard-phase powder in (b) is WC powder.

7. The method of claim 1, wherein the metal powder in (a) is Co powder, and the hard-phase powder in (b) is WC powder.

8. The method of claim 1, wherein (c) is performed using press molding, cold isostatic pressing, or powder injection molding.

9. The method of claim 7, wherein (d) is maintained at 1350˜1500° C. for 2˜6 hr.

10. The method of claim 7, wherein (d) is performed in a vacuum or in a reducible gas atmosphere.

11. A super hard alloy containing carbon nanotubes, manufactured by the method of claim 1.

12. The super hard alloy of claim 11, wherein the carbon nanotubes are contained in an amount of 0.5˜5 vol % based on a volume of the super hard alloy except for a hard phase.

13. The super hard alloy of claim 11, wherein the carbon nanotubes are dispersed in a metal binder matrix.

14. The super hard alloy of claim 11, which has a hardness (H_{V}) of 2000 or more and a toughness of (K_{IC}) of 4 MPa m^{1/2} or more.

15. The super hard alloy of claim 11, which is used for a cutting tool.

16. A cutting tool, comprising the super hard alloy containing carbon nanotubes of claim 11.

17. The cutting tool of claim 16, which includes a cutting edge, wherein the cutting edge comprises the super hard alloy containing carbon nanotubes of claim 11.
